(19) United States
(12) Patent Application Publication
(10) Pub. No.: US 2011/0249007 A1
(43) Pub. Date: Oct. 13, 2011

(54) COMPUTER RENDERING OF DRAWING-TOOL STROKES

(75) Inventors: Claudia Kuster, Zurich (CH); Johannes Schmid, Zurich (CH); Robert Sumner, Zurich (CH); Markus Gross, Ulster (CH)

(73) Assignee: Disney Enterprises, Inc., Burbank, CA (US)

(21) Appl. No.: 12/759,361

(22) Filed: Apr. 13, 2010

(51) Int. Cl. G06T 11/20

(52) U.S. Cl. 345/441

(57) ABSTRACT

A drawing-tool renderer provides real-time rendering of lines with the look of artistic line drawings. A tip of a drawing tool (e.g., pencil) can be modeled as a constellation of points representing locations on the surface (or within the volume) of the tip. For a given point on a line being rendered, the location of the point and corresponding tool-tip parameters are used to determine which points in the tool tip model touch which portions of the paper. The effect of pigment transfer on cell color is modeled realistically. Various parameters of the model can be tuned to achieve a desired balance between rendering speed and accuracy of the simulation.

### BACKGROUND

The present disclosure relates in general to computer-based rendering of images and in particular to artistic rendering of strokes emulating strokes made using a drawing tool such as pencil, crayon, chalk or the like.

Artists use a variety of tools to deposit pigments onto a surface (paper, canvas, wood, etc.) One class of artist's tools, referred to herein as “drawing tools,” incorporates a solid mass of pigment or pigment-containing material, often though not necessarily shaped into a rod and sharpened at one end. The artist drags the end of the rod across a surface, and through the action of friction, portions of the solid mass are transferred to the surface, creating a visible line. Examples of drawing tools include pencils (e.g., graphite, colored, or charcoal pencils), chalk, oil chalk, and crayon.

Pencil drawing is referred to herein as representative of the larger class of drawing tools. In traditional pencil drawing, artists create images by drawing lines with a pencil on paper or another surface. Typically, an artist draws feature lines that define the edges of various objects in the image and colors in objects with pencil strokes that wholly or partially fill the visible surface of the object. A variety of pencil types can be used, including graphite pencils, charcoal pencils, colored pencils, and so on. The term “lead” is used herein to refer generally to a pigment-containing material that is transferred from pencil (or other drawing tool) to surface as the artist draws.

Pencil strokes have distinctive characteristics. For instance, pencil tips are normally prepared for drawing by sharpening the lead into a roughly conical shape with a rounded or flat end. As the artist draws, the lead erodes, altering the tip shape. Thus, pencil strokes tend to get wider as a pencil continues to be used (unless, of course, the artist sharpens the pencil again). The angle at which the artist holds the pencil can also affect how much lead is transferred for a given tip shape. Surface roughness of the paper and pressure of the artist's hand also affect how much of the lead is left behind on the paper, creating uneven pigment density, ragged edges and so forth.

Similar effects are observed with respect to other drawing tools. As the pigment material is transferred from the tool to the surface, the material erodes, altering the shape at the area of contact between the tool and the surface. Angle, surface roughness, and pressure all affect the look of lines made with various drawing tools.

Attempts have been made to artificially generate images with the look of handmade drawings using a computer, computer system, or device capable of computing (“a computing device” as used herein). For example, colored pencil drawing has been simulated by Takagi et al. [TNF99], who modeled three-dimensional microstructure of the paper, including the effects of pigment distribution and pigment redistribution. These models, while producing convincing results, are characterized by long rendering times (e.g., several minutes) that make them unsuited for real-time, interactive drawing applications, due to the delay between when the artist inputs a stroke and when the rendered stroke can appear on a display. Sousa and Buchanan [SB00] provided a model of graphite pencils interacting with paper that includes parameters such as tip shape of the pencil, composition of the lead, applied pressure, and microstructure of the paper. This model may allow real-time rendering, but it is limited to a small number of tip shapes.

Simulations or models of other drawing tools have also been attempted. For example, a model for a wax crayon interacting with paper has been proposed by Rudolf et al. [RMN03][RMN05]. Still other models provide stylized rendering of automatically detected feature lines. Examples in this category include Northrup and Markosian [NM00] and Isenberg et al., [IHS02]. Kalnins et al. have provided a system in which a user can annotate a 3-D model with strokes to provide a stylized look [Kal04]. Additional investigations related to using stroke thickness to impose a certain drawing style have been made by Goodwin et al. [GVH07], Sousa et al. [SP03], and DeCarlo et al. [DFR04].

Improved simulations of drawing-tool strokes that allow for real-time rendering with flexible tip models would therefore be desirable.

### SUMMARY

Certain embodiments of the present invention provide rendering techniques for simulating drawing-tool strokes that balance accuracy (i.e., results that look like the work of an artist) with speed. Some embodiments provide computing devices that support real-time stroke rendering, allowing an artist to draw lines, e.g., using a tablet or similar input device, and see the lines appear in a displayed image with negligible delay. Certain embodiments provide flexibility, allowing a user to optimize tradeoffs between accuracy and speed of rendering.

In some embodiments, the tip of a drawing tool (e.g., pencil, crayon, chalk, oil chalk) is modeled as a constellation of points representing locations on the surface of the tip (or in other embodiments locations within the volume of the tip). For a given point on the line, the location of the point and corresponding stroke parameters (pressure, tilt angle, and rotation angle to allow for asymmetric tip shapes) are used to define a “footprint” of the drawing tool that touches the paper. The footprint consists of a number of points selected from the tip model, with the selection being based on distance from an nominal paper surface; the number of points in the footprint can be limited based in part on pressure.

The paper (or other drawing surface) is modeled as an array of cells of varying height, representing surface roughness. To render a point, the tool footprint is centered at the (x, y) position of a point on the line, and cells in the paper model that are touched by (i.e., have matching (x, y) coordinates with) the footprint are identified. A probabilistic model that takes into account variations in cell height due to surface roughness of the paper is applied to determine how much pigment is transferred, and a color model is used to determine the effect of the pigment transfer on cell color. In some embodiments, the color model is based on Kubelka-Munk color theory, modified to account for differences in opacity between paints and typical drawing-tool pigments such as pencil lead.

Using this model, multiple lines can be drawn on a virtual sheet of paper, using the same tool or different tools. The results can be stored and/or displayed, e.g., in the form of pixel colors for a display device. In some embodiments, results are displayed in real time, allowing the user to “draw” on screen with a similar experience to drawing on paper.

The model provides a number of parameters that can be adjusted to achieve a desired tradeoff between rendering speed and accuracy (i.e., how closely the rendered line resembles a real drawing-tool line to a human observer).

A range of drawing tools can be modeled, such as pencils (including graphite pencil, colored pencil, charcoal pencil), chalk, oil chalk, and crayon.

One aspect of the present invention relates to a digital drawing system that emulates interaction of a drawing tool with a drawing surface. The system includes a stroke renderer that provides a drawing tool tip model that includes a constellation of tip points and a drawing surface model that includes a plurality of cells of different heights. The stroke renderer can receive data from an input drawing device, where the data includes line parameters associated with a stroke to be rendered, the line parameters including a sequence of points. Based on the line parameters, the stroke renderer renders the stroke. Rendering the stroke can include, for each point in the sequence of points, modifying the drawing surface model to emulate transfer of pigment from the drawing tool tip to the paper at the point and modifying the drawing tool tip model to emulate erosion of the drawing tool tip.

Another aspect of the present invention relates to a method for generating an image using a drawing tool model and a paper model stored in a memory of a computer system. The drawing tool model includes tip point data representing a constellation of tip points arranged in a tip shape. The paper model includes cell data for an array of cells, with the cell data for each cell including a cell height and a cell color. A line consisting of points is rendered by successively rendering each point on the line. Rendering a point can include determining an intersection of the constellation of tip points and one or more of the cells; for each cell that intersects the constellation of tip points, computing an updated color and storing the updated color in the paper model; and updating the drawing tool model to emulate erosion of the tip prior to rendering a next point on the line.

The methods described can be implemented in a computer, for instance using a programmable processor. As such, program code for directing a processor to perform various acts associated with methods described herein can be stored on a computer readable medium.

The following detailed description together with the accompanying drawings will provide a better understanding of the nature and advantages of the present invention.

### BRIEF DESCRIPTION OF THE DRAWINGS

FIG. 1 illustrates a video system according to embodiments of the present invention.

FIG. 2 illustrates elements of the video system of FIG. 1 in more detail.

FIG. 3 illustrates elements of the video system in other detail including an editing station.

FIG. 4 illustrates a variation wherein an animation database forms central storage for various processing and edits.

FIG. 5 illustrates an example artist editing system usable for animation management according to an embodiment of the present invention.

FIG. 6 is a block diagram of a pencil rendering processor 600 according to an embodiment of the present invention.

FIG. 7 illustrates basic features of a model of a pencil interacting with paper as used in embodiments of the present invention.

FIG. 8 is a flow diagram of a process that can be used to render a pencil stroke based on the model illustrated in FIG. 7 according to an embodiment of the present invention.

FIGS. 9A-9F are geometric illustrations of examples of pencil tips represented as a constellation of tip points according to various embodiments of the present invention

FIGS. 10A and 10B illustrate models of paper textures according to an embodiment of the present invention.

FIG. 11 is a flow diagram of a process for modeling pencil and paper interaction at a point on a line according to an embodiment of the present invention.

FIG. 12 illustrates a coordinate system that can be used to define a pencil footprint according to an embodiment of the present invention.

FIG. 13 is a flow diagram illustrating a process for defining a pencil footprint according to an embodiment of the present invention.

FIGS. 14A and 14B are a side view and a top view illustrating a model of a pencil interacting with paper represented by cells according to an embodiment of the present invention.

FIG. 15 is a flow diagram of a process that can be used to identify cells touched by a pencil footprint according to an embodiment of the present invention.

FIGS. 16 and 17 are examples of images rendered using the techniques described herein.

### DETAILED DESCRIPTION OF EXEMPLARY EMBODIMENTS

Certain embodiments of the present invention provide rendering techniques for simulating drawing-tool strokes that balance accuracy (i.e., results that look like the work of an artist) with speed. Some embodiments provide computing devices that support real-time stroke rendering, allowing an artist to draw lines, e.g., using a tablet or similar input device, and see the lines appear in a displayed image with negligible delay. Certain embodiments provide flexibility, allowing a user to optimize tradeoffs between accuracy and speed of rendering.

In some embodiments, the tip of a drawing tool (e.g., pencil, crayon, chalk, oil chalk) is modeled as a constellation of points representing locations on the surface of the tip (or in other embodiments locations within the volume of the tip). For a given point on the line, the location of the point and corresponding stroke parameters (pressure, tilt angle, and rotation angle to allow for asymmetric tip shapes) are used to define a “footprint” of the drawing tool that touches the paper. The footprint consists of a number of points selected from the tip model, with the selection being based on distance from an nominal paper surface; the number of points in the footprint can be limited based in part on pressure.

The paper (or other drawing surface) is modeled as an array of cells of varying height, representing surface roughness. To render a point, the tool footprint is centered at the (x, y) position of a point on the line, and cells in the paper model that are touched by (i.e., have matching (x, y) coordinates with) the footprint are identified. A probabilistic model that takes into account variations in cell height due to surface roughness of the paper is applied to determine how much pigment is transferred, and a color model is used to determine the effect of the pigment transfer on cell color. In some embodiments, the color model is based on Kubelka-Munk color theory, modified to account for differences in opacity between paints and typical drawing-tool pigments such as pencil lead.

Using this model, multiple lines can be drawn on a virtual sheet of paper, using the same tool or different tools. The results can be stored and/or displayed, e.g., in the form of pixel colors for a display device. In some embodiments, results are displayed in real time, allowing the user to “draw” on screen with a similar experience to drawing on paper.

The model provides a number of parameters that can be adjusted to achieve a desired tradeoff between rendering speed and accuracy (i.e., how closely the rendered line resembles a real drawing-tool line to a human observer).

### Hardware for Implementing Video System

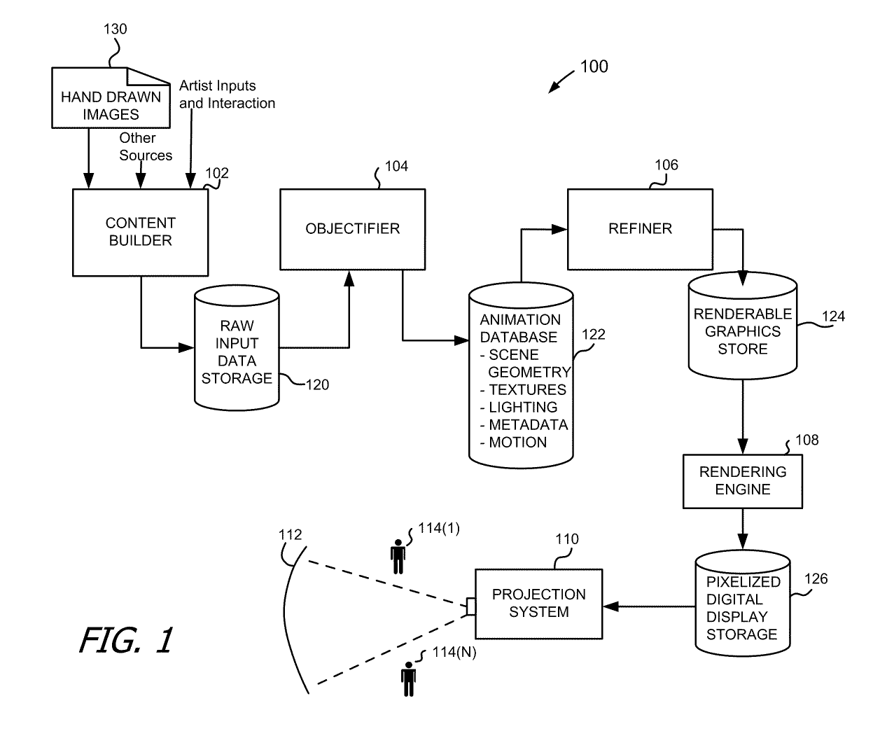

FIG. 1 illustrates a video system 100 for creating, modifying and presenting animation, comprising a content builder 102, an objectifier 104, a refiner 106, a rendering engine 108, a projection system 110 and a screen 112 on which the animation is projected for viewers 114. It should be understand that some of these elements can be implemented in software, hardware or a combination of hardware and software. The software could be separate modules or a larger system having several functions. Also, one or more of these elements could include (often not shown) memory, inputs, outputs, input devices and output devices for human, computer or electronic interfaces. It should be apparent from a reading of this description, that many of these elements can be implemented as a general purpose computer executing program code, while accepting inputs and issuing outputs and storing, reading and writing to memory allocated to that program code.

In the embodiment shown in FIG. 1, content builder 102 receives various inputs and generates raw input data, which is shown being stored in storage 120. Examples of inputs are hand-drawn images 130, artist inputs and interactions and other sources. The raw input data might include digitized images, entries by an artist to indicate how objects would behave, motion capture data, instructions, metadata, etc.

Objectifier 104 processes the raw input data to construct representative objects, i.e., data structures that represent images in object form. For example, if raw data included a scan of a hand-drawn image of a sphere, two characters and some line art, the raw data might comprise arrays of pixel values as derived from a scanner output. Objectifier 104 would process this raw data to identify the shape, locations, textures, etc. of the virtual objects represented by those pixels and store into an animation database 122 object descriptions (although in some cases, the objects might be described solely by pixel values (colors) of pixels in a pixel array. Objectifier 104 might “vectorize” pixel values to identify lines from images, a 3D modeler to identify shapes and structures from input data, a graph generator that calculates the likely connections between different objects. The resulting graph might, for example, be useful for determining animations and indicating which objects need to stay connected to what other objects or when multiple objects are subparts of a larger object structure. Objectifier 104 might also include a user interface, to allow for artists to provide inputs to an objectification process and/or provide manual corrections to the results.

In one embodiment, animation database 122 includes a collection of object descriptions (the scene geometry, 3D objects, 2D strokes), textures, lighting, motion information, such as paths that objects take over a series of frames. For example, the animation database might include storage for a collection of objects that are parts of a character and storage for motion information describing how each of those objects moves from frame to frame. In an extremely simple case, the animation database might indicate that the scene geometry includes a textured, static background, a blue cube having an edge length of 4 units of length in the virtual space, and motion data to indicate that the cube does not rotate but translates 2 units up and 1 unit to the left for three frames, then stops and drops with a specified rotation for the next 10 frames. In a much more complicated case, the animation database includes all of the objects needed to describe a scene outside a French bistro, with two characters (made up of thousands of body elements) sitting at a table and carrying on a conversation. Additionally, animation database 112 might include metadata not about the scenes to be generated, per se, but information about how the other data was generated and/or edited, for use in subsequent processing steps and/or editing steps. The animation database might be implemented in any manner of data structure and/or storage, and need not be stored in a highly-structured database management system, so long as the animation data is electronically readable.

Refiner 106 processes data from animation database 122 to refine the animation. For example, refiner 106 might include a module for determining occlusions (where one object obscures another, which is useful information when animating the front object moving away so as to show more of the back object, or where two separate regions of a view are part of the same object, but obscured by one or more front objects), a module for filling in details, such as inserting information for generating inbetween frames based on key frame information contained in animation database 112. Refiner 106 might also include a module for display compensation.

Display compensation might be done for concave screens (to compensate for screen-to-screen reflections not dealt with for flat screens), for stereoscopic presentations (to compensate for ghosting from the image bound for one eye onto the image bound for the other eye) and other display compensation. Thus, refiner 106 might have inputs for screen parameters, as well as storage for screen parameters, artist inputs, technician inputs, and the like, as might be useful for refining an animation.

The output of refiner 106 is to a store 124 for renderable graphics data. It may be in some embodiments, that animation database 112 is used for pre-refined animation and post-refined animation. Either way, rendering engine 108 can take the renderable graphics data and output pixelized digital display data that is stored in storage 126. Rendering engine 108 can run in real-time or not. The pixelized digital display can be in a raw form, such as a 2D pixel array with dimensions specified by a maximum resolution (e.g., 1920×1280, 1280×720), with each element of the array representing a pixel color value (often three or four “component” values). The pixelized digital display data might also be compressed, but the storage format need not be detailed here.

The pixelized digital display data is readable by projection system 110, which then projects the image sequences for viewing. It may be that the pixelized digital display data includes more than just arrays of pixel values, as it might include other data useful to the projection system, such as some of the data used in processing, assumptions about the screen, etc. Also, projection system 110 might also be provided with one or more synchronized audio tracks. In many cases, an animation is created by one entity, such as a filmmaker and the pixelized digital display data is distributed to a presenter in the form of digital transmission, storage on medium and transported to the presenter, such as a theater proprietor, DVDs transported and sold to end customers for small-scale viewing, medium provided to broadcasters, etc. As such, the generation of the animation might be done by one party independently of what a recipient of the medium and/or transmission does for the presentation. However, the animation process might be informed by actual or presumed details of how the presentation is to occur. As one example, the compensation might vary for varying projectors. As another example, the resolution and color depth might vary at the rendering engine (and/or elsewhere) based on formats used by presenters (such as DVD formats, vs. standard broadcast format, vs. theatre presentation).

Also the animation path, artist inputs can be accommodated. “Artist” can refer to any user that provides input, such as a graphic artist, an animator, a director, a cinematographer, their assistants, etc. Different skill levels can be accommodated. For example, not many animation skills are needed to input scanned drawings, but more skills are needed to provide inputs to the look of a particular key frame.

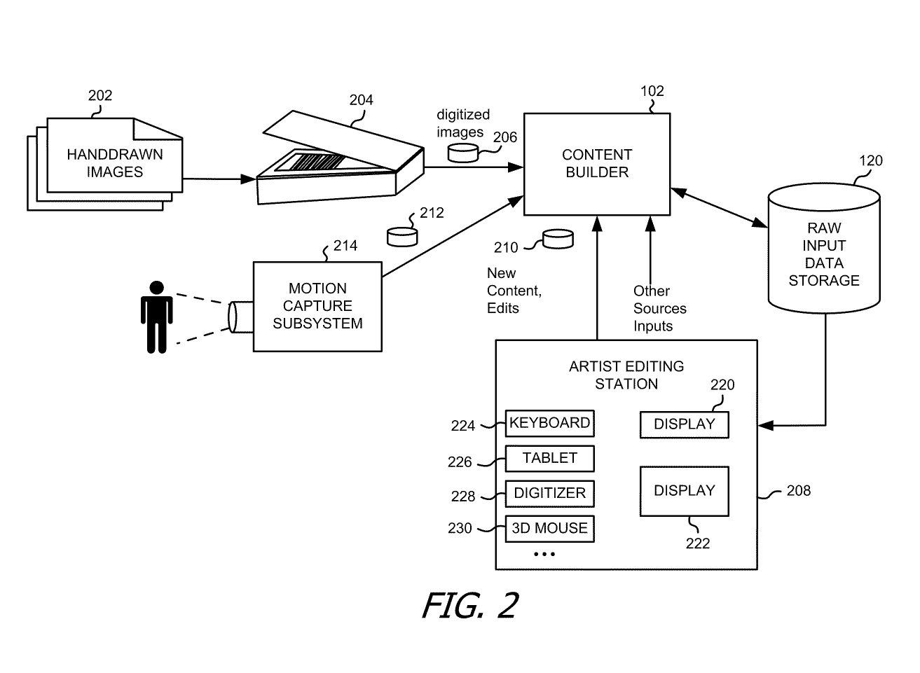

FIG. 2 illustrates elements of video system 100 in more detail. In the examples shown there, content builder 102 receives digitized images 206 from a scanner 204 when scanning hand-drawn images 202. Content builder 102 can also receive new content and edits to existing content as inputs 210 from an artist editing station 208, as well as motion capture data 212 from a motion capture subsystem 214. As illustrated, artist editing station 208 includes a keyboard 224, a tablet 226, a digitizer 228, a 3D mouse 230, a display generator 220 and a display 222. Using artist editing station 208, an artist can view the raw input data and make changes to the inputs. Artist editing station 208 might also be configured to allow for artist editing of the raw input data directly, but usually it is more convenient and/or intuitive to allow the artist to modify the inputs. For example, rather presenting a display of what the raw data represents on display 222 and requiring the artist to modify the data structures in storage 120 that represent a motion capture data point when the artist determines that something doesn't look right, it might be preferred to provide the artist with tools to specify modifications to the motion capture process (add, delete points, recapture, etc.) and have content builder 102 rebuild the raw data. This frees the artist to make artistic changes at a higher level, while providing fine control and not requiring data management experience.

In operation, multiple artists and others might edit the data in multiple rounds until the acceptable raw data is achieved. In some embodiments, as explained below, an editing station might allow for multiple stages of editing.

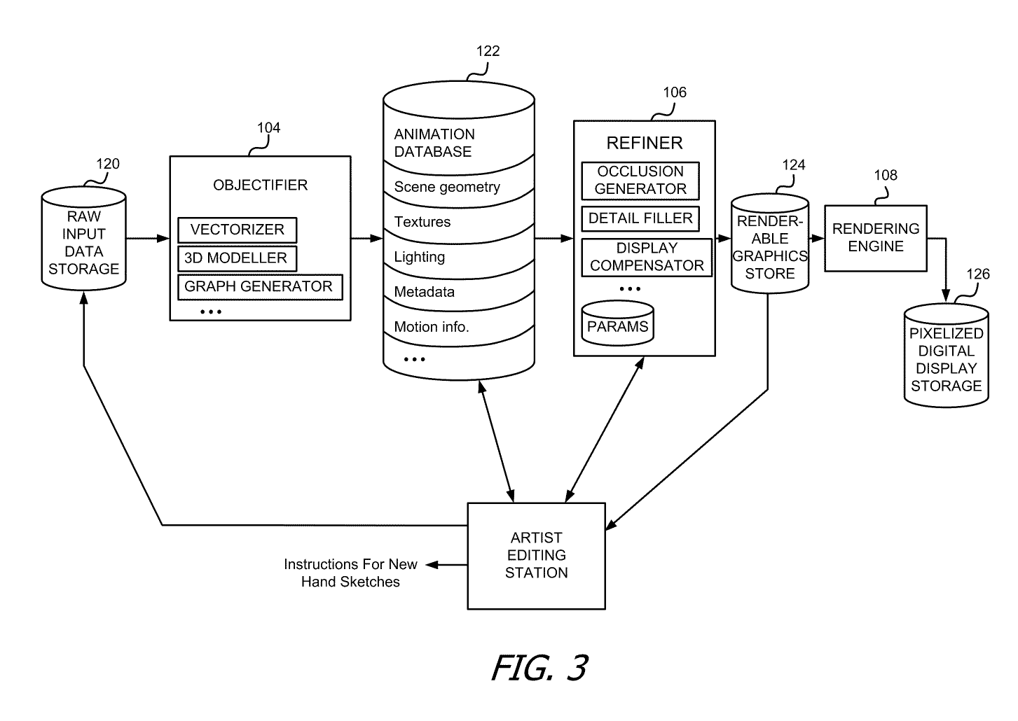

FIG. 3 illustrates elements of video system 100 in other detail illustrating such as an editing station 300. As illustrated there, editing station 300 is coupled to raw input data storage 120 to write new raw input data (and could read), coupled to animation database 122 to read and write animation data, coupled to storage 124 to read renderable graphics, and coupled to read and write parameters for refiner 106. As illustrated, objectifier 104 processes the raw input data to populate animation database 122, refiner 106 refines the (at least some of the) contents of animation database 122 and outputs it as renderable graphics, which rendering engine 108 can produce as pixelized digital display data. Thus, in concept, an entire feature film can be specified by the contents of animation database 122, it can be rendered in whole or part, reviewed at an editing station and modified. Ideally, the tools provided at the editing station are suited to high-level editing and are intuitive with what the artists are providing. In some cases, the editing station might generate instructions for additional operations needed to obtain new or additional raw input data, such as additional hand-drawn sketches and additional motion capture or CGI processing.

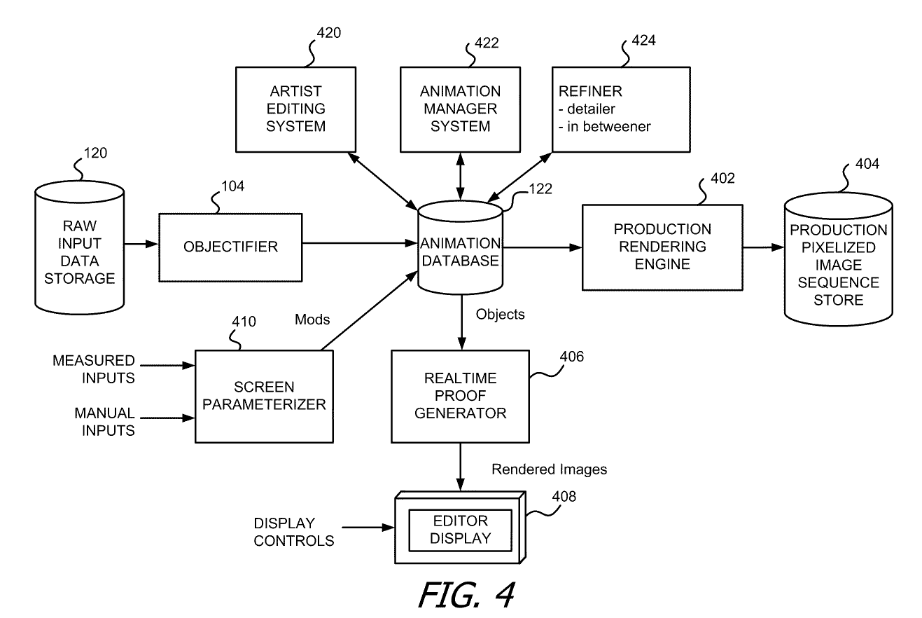

FIG. 4 illustrates a variation wherein the animation database forms the central storage for various processing and edits. As illustrated there, raw input data from storage 120 is read by objectifier 104 and written to animation database 122, as in the previous example. However, the various editors edit to animation database 122, which can then be the source for a production rendering engine 402 that renders production-quality and writes to production pixelized image sequence store 404, as well as the source for real-time proof generator 406 (which can be a lower resolution and/or quality renderer) that outputs rendered images to an editor display 408. As illustrated there, animation database 122 might receive screen information from a screen parameterizer 410 that determines, from measured inputs and/or manual inputs, parameters about the screen for which the rendering is to occur—such as its distance from the projector lens, its radius of curvature, the cross-over illumination from one stereoscopic image to another (such as cross-pollution of polarized images). Other changes can come from an artist editing system 420, an animation manager system 442, and/or a refiner 424. Artist inputs might be converted to raw input data, but typically enough information would be available to generate objects from the artist inputs.

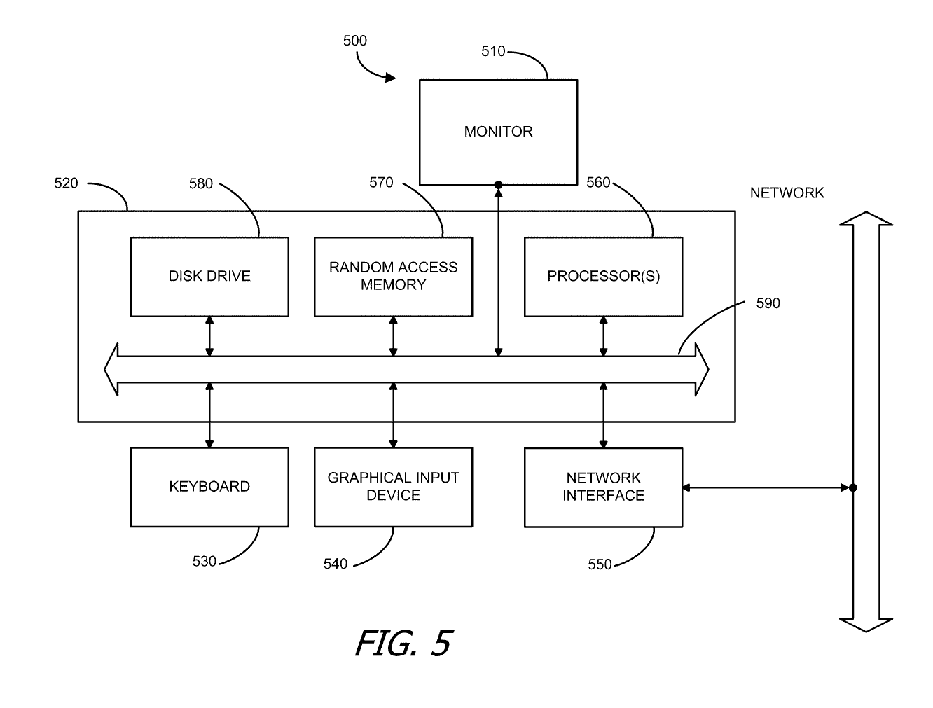

FIG. 5 illustrates an example artist editing system 500 usable for animation management according to an embodiment of the present invention. In the presently described embodiment, artist editing system 500 typically includes a display/monitor 510, computer 520, a keyboard 530, a user input device 540, computer interfaces 550, and the like. Images can be input using a scanner (not shown), received over a network or other interface, stored in memory or hard disk storage, or drawn directly into the system where such functionality is provided and/or obtained from a data storage device depicted elsewhere. The interfaces and/or memory might also be used to provide the metadata about images, animation sequences and the like.

In various embodiments, display/monitor 510 may be embodied as a CRT display, an LCD display, a plasma display, a direct projection or rear projection DLP, a microdisplay, or the like. In various embodiments, monitor 510 may be used to visually display user interfaces, images, or the like as well as being part of an interactive environment that accepts artist inputs, shows results of animation generation and metadata, etc. and accepts further input.

In the present embodiment, user input device 540 is typically embodied as a computer mouse, a trackball, a track pad, a joystick, wireless remote, drawing tablet, voice command system, eye tracking system, and the like. User input device 540 typically allows a user to select objects, icons, text and the like that appear on the display/monitor 510 via a command such as a click of a button or the like as well as making moving inputs, such as signaling a curve or association of objects, drawing lines, etc.

Embodiments of computer interfaces 550 typically include an Ethernet card, a modem (telephone, satellite, cable, ISDN), (asynchronous) digital subscriber line (DSL) unit, FireWire interface, USB interface, and the like. For example, computer interfaces 550 may be coupled to a computer network, to a FireWire bus, or the like. In other embodiments, computer interfaces 550 may be physically integrated on the motherboard of computer 520 and/or include software drivers, or the like.

In various embodiments, computer 520 typically includes familiar computer components such as a processor 560, and memory storage devices, such as a random access memory (RAM) 570, disk drives 580, and system bus 590 interconnecting the above components. RAM 570 or other memory might hold computer instructions to be executed by one or more processors as a mechanism for effecting some functionality described herein that is implemented in software. In one embodiment, computer 520 includes one or more Core™ microprocessors from Intel. Further, in the present embodiment, computer 520 typically includes a UNIX-based operating system.

RAM 570 and disk drive 580 are examples of computer readable tangible media configured to store embodiments of the present invention including computer executable code implementing techniques described herein, data such as image files, object/scene models including geometric descriptions of objects, images, metadata about images and user inputs and suggestions, procedural descriptions, a rendering engine, executable computer code, and/or the like. Other types of tangible media may include magnetic storage media such as floppy disks, networked hard disks, or removable hard disks, optical storage media such as CD ROMS, DVDs, holographic memories, and/or bar codes, semiconductor memories such as flash memories, read only memories (ROMS), battery backed volatile memories, networked storage devices, and the like.

In various embodiments, artist editing system 500 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiments of the present invention, a graphical processor unit or “GPU”, may be used to accelerate various operations.

FIG. 5 is representative of a computer system capable of embodying the present invention. It will be readily apparent to one of ordinary skill in the art that many other hardware and software configurations are suitable for use with the present invention. For example, the computer may be a desktop, portable, rack mounted or tablet configuration. Additionally, the computer may be a series of networked computers. Further, the use of other micro processors are contemplated, such as Xeon™, Pentium™ or Itanium™ microprocessors from Intel; Turion™ 64 or Opteron™ microprocessors from Advanced Micro Devices, Inc; and the like. Further, other types of operating systems are contemplated, such as Vista™ or WindowsXP™ or the like from Microsoft Corporation, Solaris™ from Sun Microsystems, Linux, Unix, or the like. In still other embodiments, the techniques described above may be implemented upon a chip or an auxiliary processing board. Many types of configurations for computational devices can be used to implement various methods described herein. Further, processing components having different levels of computational power, e.g., microprocessors, graphics processors, RISC processors, embedded processors, or the like can also be used to implement various embodiments.

### Pencil Rendering Processor

Specific embodiments in which the drawing tool to be modeled is a pencil and the drawing surface is paper will now be described. It is to be understood that other embodiments may model other drawing tools, including but not limited to pencils (such as graphite, colored, or charcoal pencils), chalk, oil chalk, crayon, and the like. Further, other embodiments may model other drawing surfaces, including but not limited to canvas, wood, concrete, plaster, and so on.

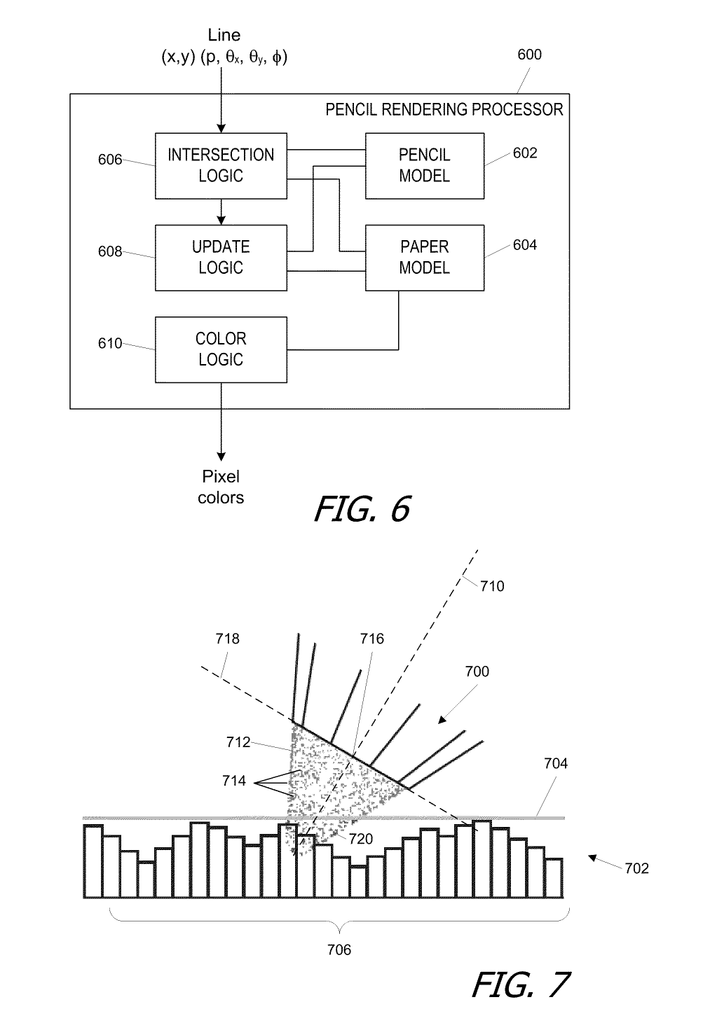

FIG. 6 is a block diagram of a pencil rendering processor 600 according to an embodiment of the present invention. Pencil rendering processor 600 can be implemented within the rendering systems described above, e.g., as program code executable by a processor and/or using dedicated logic circuits. Pencil rendering processor 600 includes storage for a pencil model 602 and a paper model 604. This storage can be, e.g., in any memory or other storage area as described above. Pencil rendering processor 600 also includes intersection logic 606, update logic 608, and color logic 610.

Intersection logic 606 receives input parameters describing a pencil line to be rendered, such as the (x, y) position of a point on the line, and corresponding pencil parameters such as pressure (p), tilt angles (θₓ, θ_{y}) relative to vertical and rotation angle (φ) about the pencil axis. Intersection logic uses the input parameters in conjunction with pencil model 602 and paper model 604 to determine which portions of paper model 604 are intersected by pencil model 602 when pencil model 602 is placed at point (x, y) on the line being rendered.

Update logic 608 updates paper model 604 to reflect deposition of pigment by the simulated pencil of pencil model 602. Update logic 608 also updates pencil model 602 to reflect erosion of the tip as a line is drawn.

Color logic 610 can compute pixel colors based on paper model 604 and deliver pixel data to other parts of the rendering system.

Specific examples of pencil and paper models, as well as algorithms that can be implemented in intersection logic 606, update logic 608, and color logic 610, are described below.

### Pencil and Paper Models

FIG. 7 illustrates basic features of a model of a pencil 700 interacting with paper 702 as used in embodiments of the present invention. Paper 702 has a nominal surface 704 and a microstructure represented as a series of cells 706 of varying height. In this side view, a single row of cells 706 is seen; in general, cells 706 can make up a two-dimensional grid, with each cell corresponding to a small square area of the paper.

Pencil 700 has an axis 710 that can be tilted at various angles and various directions relative to vertical; this tilt can be represented by a tilt angle in the xz plane (θₓ) and a tilt angle in the yz plane (θ_{y}). A pencil tip 712 is modeled as a constellation of points 714 (also referred to herein as “tip points”) with each point 714 having a defined position relative to the point 716 where pencil axis 710 meets plane 718 at the base of tip 712. As shown, pencil tip 712 is pushed into paper 702 so that part of tip 712 extends below nominal paper surface 704 and intersects some of cells 706. The portion 720 of pencil tip 712 below nominal paper surface 704 is referred to herein as a “footprint.” In some embodiments, pigment transfer is modeled for each cell that is intersected or touched by at least one point 714 within footprint 720. Modeling of pigment transfer can include modeling the effect on cell height (due to deposition of lead) as well as cell color. Erosion of the pencil led is modeled by moving points of footprint 720 that intersect or touch cells 716 upward along axis 700 (i.e., away from the paper).

### Pencil Rendering Process: Overview

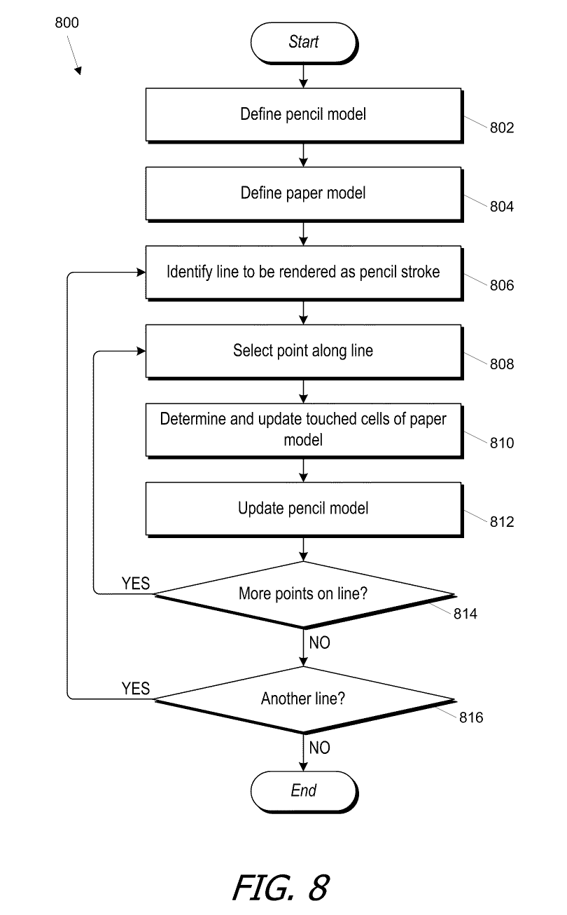

FIG. 8 is a flow diagram of a process 800 that can be used to render a pencil stroke based on the model illustrated in FIG. 7 according to an embodiment of the present invention.

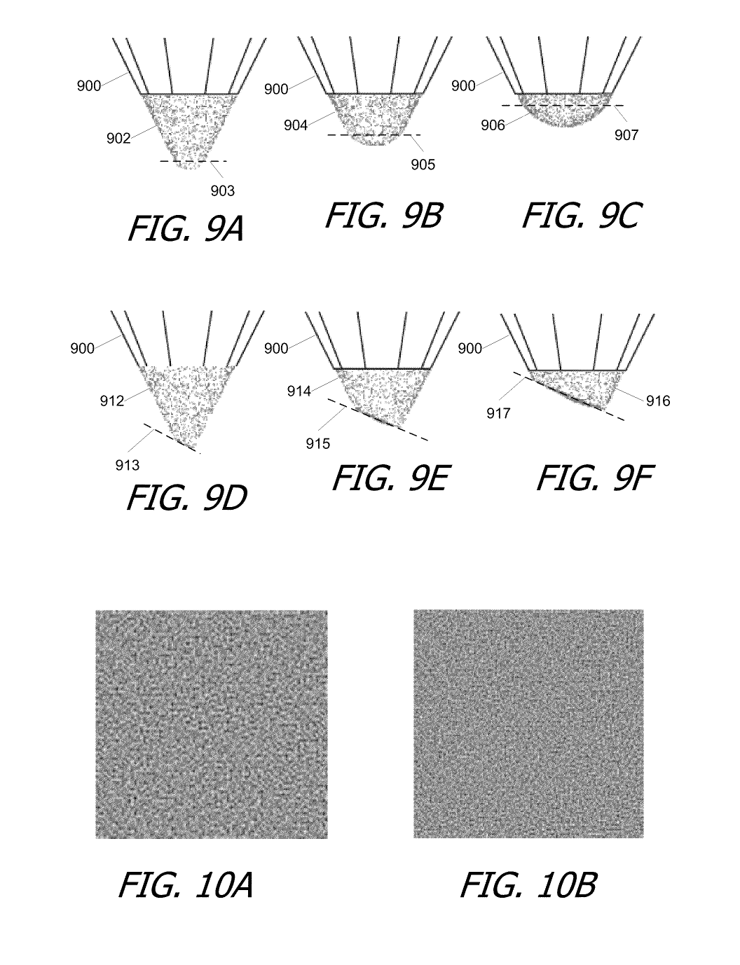

At step 802, a pencil model is defined. As described above, the pencil model can include a constellation of a large number of tip points arranged in a generally conical volume approximating a pencil tip. A variety of tip shapes can be modeled. FIGS. 9A-9F are geometric illustrations of examples of pencil tips represented as a constellation of tip points according to various embodiments of the present invention. In each case, a portion of a surrounding casing 900 of the pencil is shown to facilitate visualization; the casing need not be part of the model.

FIGS. 9A-9C illustrate various “round” tip constellations 902, 904, 906. Round tips can be modeled by defining a cone (e.g., with the same surface angle as casing 900), intersecting a plane (broken lines 903, 905, 907) at a selected distance from the end of casing 900, and replacing the portion of the cone below the plane with a spherical segment. The constellation of tip points can be created by uniformly sampling the resulting surface or volume.

FIGS. 9D-9F illustrate various “flat” tip constellations 912, 914, 916. Flat tips can be modeled by defining a cone (e.g., with the same surface angle as casing 900) and intersecting the cone with a plane (broken lines 913, 915, 917) at a selected angle relative to the axis of the pencil. Again, the constellation of tip points can be created by uniformly sampling the resulting surface or volume.

In some embodiments, the tip points are sampled only on the surface of the pencil tip. For example, tip points can be generated by using an acceptance-rejection method to uniformly sample points on a cone: points can be randomly sampled on a square and accepted if they belong to the spherical segment that corresponds to the shape of the flattened cone. The accepted points are then mapped back to the three-dimensional cone. Sample density can be selected as desired; in one embodiment, 1000 points uniformly distributed over the surface are used; other numbers can be used based on the desired speed of simulation. In general, using more points can improve accuracy but can also reduce rendering speed on a given system.

In another embodiment, the volume of the pencil tip can be sampled, e.g., using uniform sampling. The sample density can be set as desired. For a given sample density, volumetric, rather than surface, sampling increases realism but reduces rendering speed.

The tip shapes shown in FIGS. 9A-9F are illustrative and other tip shapes may be used. Real-world pencils vary in lead thickness and density, and real-world pencil sharpeners vary in the angle at which they cut the pencil. Any such variations can be modeled in a pencil tip, and in some embodiments, the user can specify parameters for the pencil model such as width and density of the graphite, tip cone angle, flat or round, and angle of cutoff for flat tips or radius of curvature for round tips. A constellation of points can then be generated based on the user-specified parameters. In another embodiment, the user can select a tip shape from a menu of possible tip shapes.

It is to be understood that the tips shown in FIGS. 9A-9F can be initial models that are subsequently evolved to represent graphite erosion, e.g., as described below.

Referring again to FIG. 8, at block 804, a paper model is defined. In some embodiments, paper is modeled as a grid of cells. The size of each cell can be equal to the size of a pixel in the final image, although smaller cells can also be used for finer granularity and potentially improved accuracy. Each cell is initially assigned a height to reflect surface roughness of the paper. The height can be modeled using a random or pseudorandom texture, such as a Perlin noise field.

Depending on the parameters of the texture used to define cell height, different degrees of surface roughness can be obtained. For example, FIG. 10A illustrates a rough textured paper, while FIG. 10B illustrates a smoother texture. In some embodiments, paper texture can be selected by the user, e.g., by selecting a point on a continuum between maximum and minimum roughness, and the parameters used to generate the surface texture can be adjusted based on the user selection.

Referring again to FIG. 8, at block 806, a line to be rendered is identified. Preferably, identifying the line includes identifying pixels touched by the line (e.g., by rasterizing the line) and also identifying a direction of drawing. The line width at this stage can be a single pixel; thickness of the pencil is taken into account in subsequent steps as described below.

In some embodiments, real-time line rendering is supported. A user can, for example, draw with a pen or stylus on a position-sensitive pad to define the position and direction of the line. In other embodiments, a line to be rendered can be generated automatically. For example, existing algorithms for feature line detection in a 3-D rendered image can be used, and a direction of drawing can be automatically assigned to the feature line. Particular techniques for identifying a line are not critical, and a detailed description is omitted.

In some embodiments, identifying a line may also include identifying pencil parameters such as tilt angles (tilt of the pencil axis relative to vertical, in x and y directions), rotation (since the tip may be asymmetric), and drawing pressure. These parameters can be uniform along the line or vary as the line is drawn; varying the parameters generally produces a more realistic result as most artists do not use constant pressure, rotation or tilt angle. Where real-time line rendering is implemented, a pressure-sensitive pad or stylus can be used to measure the actually parameters as the user draws the line. Where automated line generation is used, the program can automatically assign pencil parameters to each generated line. For example, observation of artists drawing lines suggests that pencil pressure typically increases near the beginning of a line, stays roughly constant in the middle, then decreases near the end; thus, the beginning and end of a line tend to look a bit faded. Tilt angle can be chosen to mimic the wrist action of a user: short lines tend to involve more wrist action, causing tilt angle to vary, while longer lines tend to be drawn with the arm, resulting in little or no variation in tilt angle. Rotation can be treated as constant within each line but different for successive lines. This mimics the typical behavior of an artist, who will rotate the pencil between lines to use the lead from all sides.

In some embodiments, a user can specify pressure, tilt, and/or rotational parameters for a particular line or adjust default values.

At block 808, a point (x, y) in the rasterized line is selected. Selection of points can follow the direction of line drawing, thus allowing pencil erosion in the course of drawing a single line to be emulated. Thus, initially, the first point in the line (in the direction of drawing) is selected.

At block 810, touched cells of the paper model are identified and updated. As described below, this can be implemented by determining which cells of the paper are touched by tip points in the pencil tip when the center of the pencil is at (x, y) and emulating the effect of pigment transfer at that cell. This can include updating the cell height as well as the cell color.

At block 812, the pencil model can be updated to reflect the effect of leaving pigment in the touched cells. In one embodiment, this is done by moving points within the constellation that defines the tip; alternatively, points can be deleted from the constellation.

At block 814, process 800 can determine whether more points remain in the line. If so, process 800 can return to block 808 to select the next point in the line, preferably proceeding sequentially along the direction of drawing. Blocks 810 and 812 are repeated using the model as modified by any previous iteration(s) as many times as needed to complete drawing of the line. It should be noted that the same cell can be touched when the pencil center is at multiple points along the line, and this can has the effect of transferring additional pigment to the cell. Thus, cells closer to the center line of the trajectory will likely receive more pigment than cells farther from it, and this is consistent with the look of a real pencil stroke.

At block 816, process 800 can determine whether to process another line using the current pencil and paper models. If another line is to be processed, process 800 can return to block 806 to identify the line. This allows the user to model drawing several lines sequentially with the same pencil, as the tip erodes further every time a line is drawn.

If no more lines are to be drawn, process 800 can end. It is to be understood that a user can continue to add lines to the same drawing. For example, the user can continue to draw lines using the same pencil model, which will continue to erode as more lines are drawn. The user can also select or define a different pencil (e.g., with a different color or tip shape) while the new lines continue to be applied by updating the existing paper model. In some embodiments, any pencil defined by the user can be stored for later selection, and the pencil can continue to erode as it is used until and unless the user chooses to “sharpen” the pencil (e.g., by redefining the tip shape).

### Identifying Touched Cells

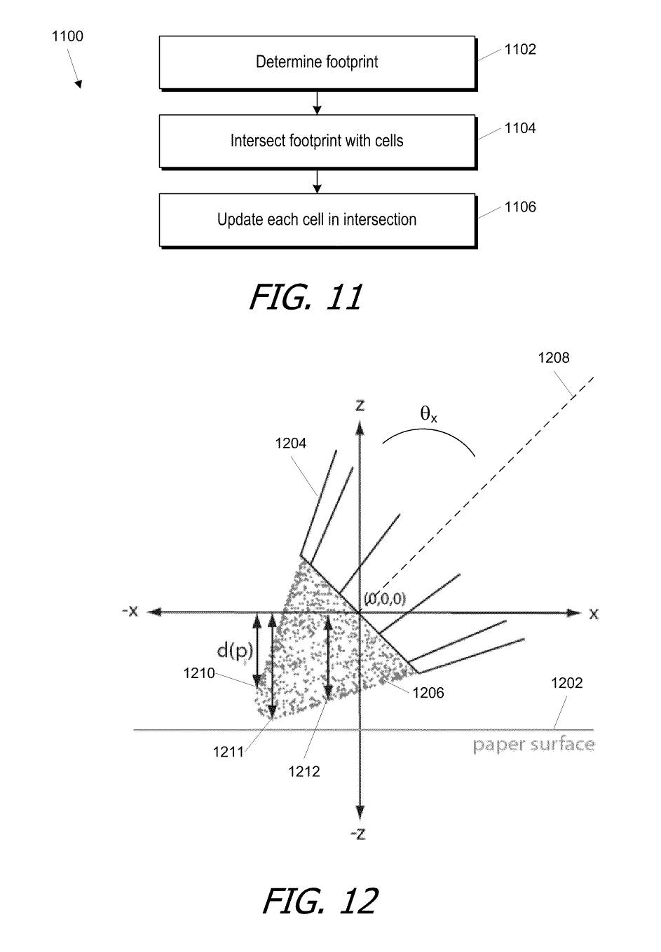

In some embodiments, identifying and updating cells touched by an emulated pencil can be done in an efficient manner that supports real-time rendering of pencil strokes. For example, FIG. 11 is a flow diagram of a process 1100 that can be implemented at block 810 of FIG. 8 according to an embodiment of the present invention.

At block 1102, a “footprint” for the pencil tip on the paper is determined. At block 1104, the footprint is intersected with the cells to determine which cells are touched (or penetrated) by pigment. At block 1106, each cell that is touched by pigment can be updated. A more specific example of such a process will now be described.

In some embodiments, the pencil footprint is determined by successively “pushing” tip points of the constellation into a nominal surface of the paper until an upper limit is reached. This upper limit can be determined based on a pressure parameter (which can be measured or selected, e.g., as described above).

### Defining Pencil Footprint

FIG. 12 illustrates a coordinate system that can be used to define a pencil footprint according to an embodiment of the present invention. In this coordinate system, the (x, y) plane is parallel to nominal paper surface 1202 and an arbitrary distance above it. The z axis is normal to the paper surface and increases in a direction moving away from the paper. The origin is placed along the axis 1208 of pencil 1204 at the base of the conical part of tip 1206. Pencil 1204 can be tilted relative to the z axis, and the tilt angle (θ) can be a user-selectable parameter. (In some embodiments, a pen or stylus type input device may include an accelerometer or the like that can be used to measure tilt angle.)

For each point pᵢin the constellation of tip points, a distance d(pᵢ) to the (x, y) plane is defined as shown by arrows 1210-1212. In some embodiments, points with a positive z coordinate are ignored. Points with the largest d(pᵢ) are closest to the paper, and it can be useful to sort the points in order of decreasing d(pᵢ).

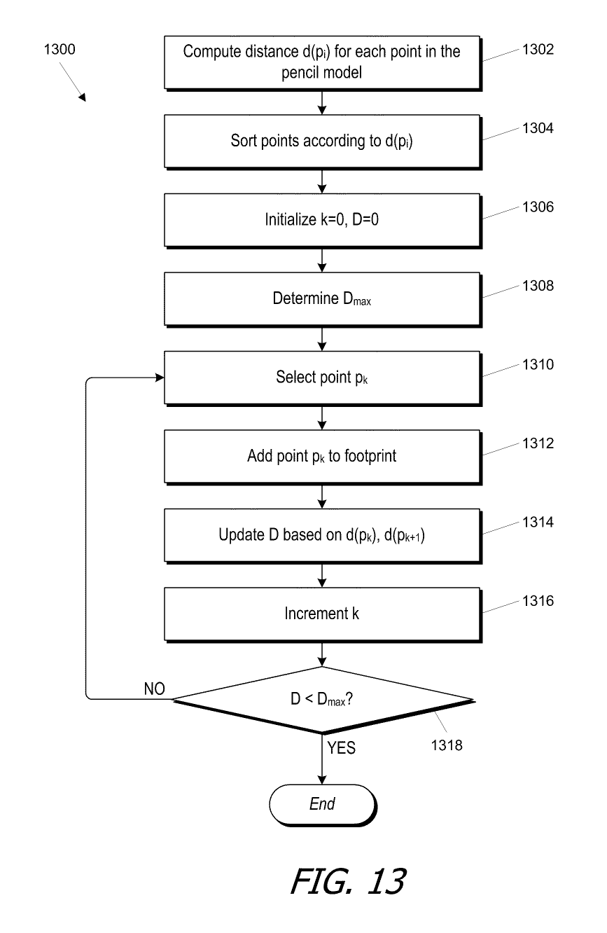

Thus, in some embodiments, the pencil footprint is defined by adding points in order of decreasing d(pᵢ), without regard to the (x, y) positions of the points until an upper limit on the number of points is reached. FIG. 13 is a flow diagram illustrating such a process 1300 for defining a pencil footprint.

At block 1302, distance d(pᵢ) is computed for each point in the pencil footprint, e.g., using the coordinate system of FIG. 12. At block 1304, the points are sorted by decreasing d(pᵢ), so that the point with the largest d(pᵢ) is first in the sorted list.

At block 1306, a counter k and a surface area parameter D are initialized (e.g., to zero).

At block 1308, an upper limit Dₘₐₓon the surface area parameter D is determined. In some embodiments, Dₘₐₓ depends on applied pressure, which can be measured or selected, e.g., as described above. For example, in one embodiment,

Dₘₐₓ=p*scale, (Eq. 1)

where p is the pressure at the current point (e.g., on a scale from 0 to 1, where 0 is no pressure and 1 is a maximum pressure) and scale represents the largest fraction of the pencil tip that is allowed to contact the paper, for example 0.5. These parameters can be varied as desired.

In one sense, Dₘₐₓ can be viewed as a maximum penetration depth for the pencil into the paper, which depends in part on the downward force exerted by the user on the pencil and in part on the shape of the pencil tip. For example, for the same applied force, a sharper tip can go deeper into the paper surface because the force is more concentrated.

In another sense, selecting Dₘₐₓ can be viewed as an optimization problem. On one hand, increased force tends to increase the penetration depth of the pencil and therefore the number of points in the footprint. On the other hand, deeper penetration widens the footprint and reduces the pressure at each point, which in turn decreases penetration depth. Thus, the goal may be to find a balance between pressure and surface area.

At block 1310, a first point pₖ(for k=0) is selected from the sorted list. This is preferably the point with the largest d(pᵢ) as described above. The selected point pₖis added to the footprint (which can just be a list of points) at block 1312.

At block 1314, surface area parameter D is updated. In one embodiment, the update is as follows:

D=D+k*sampleDensity*(d(pₖ)−d(pₖ₊₁)). (Eq. 2)

At block 1316, counter k is incremented (e.g., by adding 1). At block 1318, if D is less than Dₘₐₓ, process 1300 returns to block 1310 to select and add the next point on the sorted list to the footprint. Once D reaches or exceeds Dₘₐₓ, process 1300 ends.

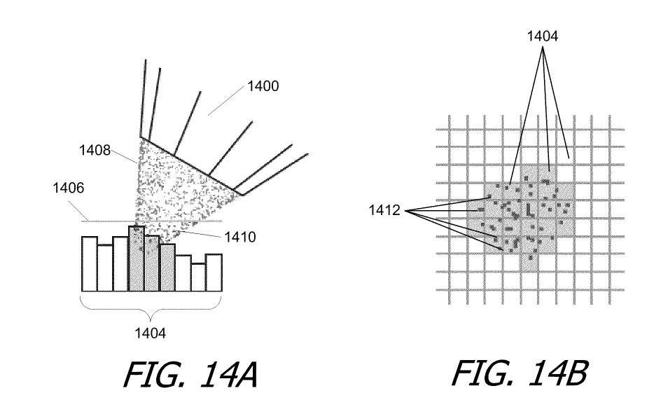

This footprint can be intersected with cells of the paper model. More specifically, if pₗ (for some arbitrary l) was the last point added to the footprint, the nominal paper surface can be placed at z=−d(pₗ) in the coordinate system of FIG. 12, so that the footprint is below the nominal paper surface, e.g., as shown in FIG. 7. As described above, each cell has a height, which corresponds to a deviation in the z direction from the nominal paper surface. This is illustrated in FIG. 14A, which is a side view showing a model of pencil 1400 interacting with paper represented by cells 1404. Each cell 1404 has a height relative to nominal paper surface 1406. Pencil tip 1408 partially penetrates into nominal paper surface 1406 up to the depth of footprint 1410, which can be determined as described above. Some of cells 1408 are touched by tip points in footprint 1410.

Further illustrating, FIG. 14B is a top view of paper cells 1404 and selected tip points 1412. Cells 1404 that are touched by at least one tip point 1412 are shaded gray.

### Identifying Cells Touched by Footprint

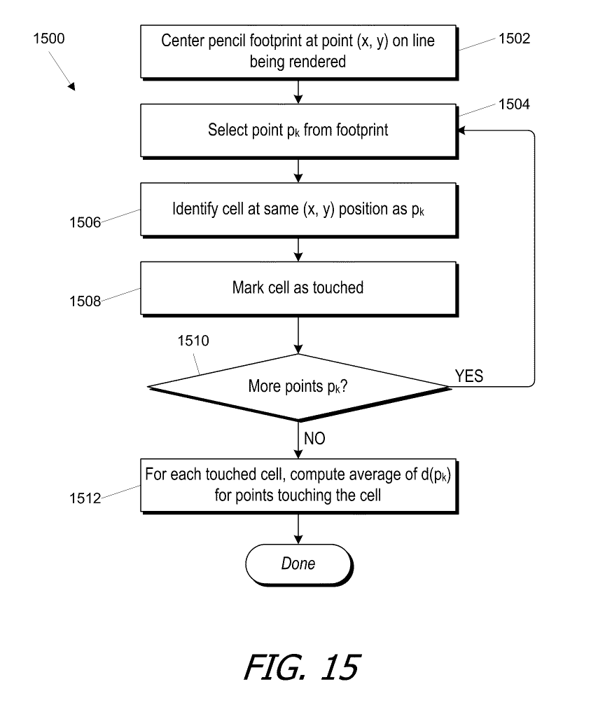

FIG. 15 is a flow diagram of a process 1500 that can be used to identify cells touched by the pencil footprint according to an embodiment of the present invention. Process 1500 involves iterating over each point in the footprint to identify which, if any, cell is touched or penetrated by that point.

At block 1502, the pencil footprint is centered at a point (x, y) on the line to be rendered. At block 1504, a point pₖis selected from the footprint; points can be selected in the order they were added or in a different order. At block 1506, the coordinates (xₖ, yₖ) of point pₖ can be determined and used to select a candidate cell having the same coordinates. That cell is marked as being touched by the pencil at block 1508. In some embodiments, multiple points pₖ can touch the same cell, and a count is maintained of how many points pₖ touch a particular cell. In some embodiments, the penetration depth d(pₖ) of each point that touches a cell can also be stored. This count can be used, e.g., in determining color and/or updating cell height as described below.

At block 1510, if more points remain in the footprint, process 1500 returns to block 1504 to select another point. Once all points in the footprint have been considered, at block 1512, an average penetration depth d_{avg}is computed for each touched cell, e.g., averaging the d(pₖ) values for the points that touch the cell. In an alternative embodiment, the average depth d_{avg} can be updated each time a point is identified as touching a cell. After block 1512, process 1500 ends.

### Updating Touched Cells

Each touched cell can be updated to reflect pigment deposition. A real pencil deposits pigment on paper, which increases the height of the paper at that point. In simulation, height of a cell in the paper model can be updated to reflect the amount of pigment deposited.

In general, higher regions of a paper can be expected to receive more pigment; however, at the same time, typical pencil pigments have less adhesion to pigment layers than to blank paper. Accordingly, a probabilistic model can be used to determine how much pigment attached to a cell. In one such model, the probability μ of pigment attaching to a cell c is:

$$μ ( c ) = \{ \begin{matrix}{μ}_{0} ( 1 - \frac{h}{{h}_{sat}} ) + {μ}_{1} \frac{h}{{h}_{sat}} , & h \leq {h}_{sat} \\ {μ}_{1} & h > {h}_{sat} .\end{matrix} \qquad ( Eq . 3 )$$

In (Eq. 3), h is the height of any previous color layer at the cell, hₛₐₜis a threshold height used to determine whether the cell is already saturated with pigment, μ₀is the probability of pigment attaching to an unsaturated cell, and μ₁is the probability of pigment attaching to a saturated cell. The parameters hₛₐₜ, μ₀ and μ₁ can be varied to optimize performance; in one embodiment, hₛₐₜ=0.5, μ₀=0.2, and μ₁=0.05.

Height of the pigment layer can then be determined by:

h_{layer}=μ(c)*overlap, (Eq. 4)

where overlap is in the closed interval [0 . . . 1] and denotes the percentage of the paper's height that is occupied by pencil points touching or intersecting the cell. In one embodiment, overlap is computed by comparing the average penetration depth d_{avg} for a cell (as computed in process 1500 described above) to the cell height. If the overlap is negative, i.e., if the cell is not penetrated by the average of the points that touch it, then overlap can be set to zero, leaving cell height and color unchanged. In this embodiment, overlap does not depend on the number of points that touch the cell, only on the average penetration depth of those points.

Next, the effect of the new pigment layer on cell color is determined. For example, a color model based on Kubelka-Munk color theory [KM31][Kub54][Kor69][HM92] can be used. Kubelka-Munk color theory, known in the art, models a colorant layer of thickness d applied to a substrate and takes into account that some light will be absorbed in the colorant layer while some light will be reflected. In this theory, a colorant can be characterized by a absorption coefficient per unit length (K) and a scattering coefficient per unit length (S). Given these parameters, the effect of a layer of colorant of a given thickness can be computed.

In embodiments of the present invention, the pencil model for a given pencil can include its absorption and scattering coefficients as its colorant properties. In some embodiments, absorption and scattering coefficients measured for a real colorant (e.g., a real pencil pigment) can be used to represent a particular pencil.

Alternatively, a user can specify the desired appearance of a unit thickness of a pigment over black and white backgrounds as colors (reflectances) R_{b} and R_{w} respectively, and the colorant properties can be determined using a model developed by Curtis et al. [CAS97] In this model, scattering and absorption coefficients S and K can be computed from R_{b} and R_{w} as follows:

$$\begin{matrix}a = \frac{1}{2} ( {R}_{w} + \frac{{R}_{b} - {R}_{w} + 1}{{R}_{b}} ) , & ( Eq . 5 ) \\ b = \sqrt{{a}^{2} - 1} , & ( Eq . 6 ) \\ S = \frac{1}{b} {coth}^{- 1} ( \frac{1 - {aR}_{b}}{{bR}_{b}} ) , and & ( Eq . 7 ) \\ K = S ( a - 1 ) . & ( Eq . 8 )\end{matrix}$$

A further simplification can also be provided [YMI04], in which the user selects a color for the pencil, e.g., using a standard color picker in RGB or other color space. The color selected by the user is identified as R_{w}, and R_{b}is computed using an opacity parameter α defined on the interval [0 . . . 1]:

R_{b}=αR_{w}. (Eq. 9)

The opacity parameter α can be assigned a default value, e.g., 0.5, which the user can vary to produce the desired effect. In some embodiments, the colors (and therefore K and S) are specified as RGB triplets.

Kubelka-Munk color theory was developed for paint layers, which are usually more transparent than pencil pigments. In some embodiments of the present invention, a correction the absorption coefficient K can be made to account for the relatively higher opacity of pencil pigments. For example, as can be seen from Eqs. 5-8, for small values of R_{w}, K goes to infinity. This causes the reflected light R to become zero regardless of the layer thickness, which does not accurately model the behavior of thin layers.

It is observed that K>1 is a non-physical condition, as the fraction of light being scattered cannot exceed the total incident light. Accordingly, K can be clamped at 1.

In one embodiment, the following appearance parameters are used to characterize the color of each cell:

K: absorption coefficient of the cell (per unit thickness of pigment);

S: scattering coefficient of the cell (per unit thickness of pigment);

R: reflectance of the pigment layer; and

T: transmittance of the pigment layer.

Current values of these parameters are stored for each cell. In some embodiments, each parameter is represented as an RGB color triplet. In addition, the thickness d of the pigment layer on the cell is also stored.

Initially, no pigment is present on any cell. Thus, the initial values of the cell color parameters can be:

d=0.0

K=(0.0,0.0,0.0)

S=(0.0,0.0,0.0)

R=(0.0,0.0,0.0)

T=(1.0,1.0,1.0) (Eq. 10)

Each time pigment is applied to the cell, properties of the new pigment layer can be computed. Let S₂ and K₂ be the scattering and absorption coefficients of the new layer (which can be defined for a particular pencil as described above with reference to Eqs. 5-8), and let d₂=h_{layer}be the thickness of the new layer (which can be computed using Eqs. 3 and 4). The reflectance R₂ and transmittance T₂ of the new layer can then be computed according to the following equations:

$$\begin{matrix}{R}_{2} = \frac{1}{a + b coth {bS}_{2} {d}_{2}} , and & ( Eq . 11 ) \\ {T}_{2} = \frac{b}{a sin h {bS}_{2} {d}_{2} + b cosh {bS}_{2} {d}_{2}} . & ( Eq . 12 )\end{matrix}$$

The new layer is then combined with the existing cell color parameters (d, K, S, R, T) by setting d₁=d, K₁=K, S₁=S, R₁=R, T₁=T, and computing new cell values:

$$\begin{matrix}d = {d}_{1} + {d}_{2} . & ( Eq . 13 ) \\ S = \frac{{d}_{1}}{{d}_{1} + {d}_{2}} {S}_{1} + \frac{{d}_{2}}{{d}_{1} + {d}_{2}} {S}_{2} , & ( Eq . 14 ) \\ K = \frac{{d}_{1}}{{d}_{1} + {d}_{2}} {K}_{1} \frac{{d}_{2}}{{d}_{1} + {d}_{2}} {K}_{2} , & ( Eq . 15 ) \\ R = {R}_{1} + \frac{{T}_{1}^{2} {R}_{2}}{1 - {R}_{1} {R}_{2}} , and & ( Eq . 16 ) \\ T = \frac{{T}_{1} {T}_{2}}{1 - {R}_{1} {R}_{2}} . & ( Eq . 17 )\end{matrix}$$

These computations can be repeated each time another pigment layer is added to the cell.

To render the cell, the cell color is combined with the color of the paper. Specifically, if Rₚis the color of the paper and R is the cell's R parameter, then the color to be rendered is computed as:

$$Color = R + \frac{{T}^{2} {R}_{p}}{1 - {RR}_{p}} . \qquad ( Eq . 18 )$$

It should be noted that color spaces other than RGB can be used. Where users specify all colors as RGB triplets, the use of color models derived from RGB works well, although the result may not exactly match a real colorant; for best matching of real colorants, measurements of spectral properties of those colorants can be employed.

### Simulating Pencil Erosion

To realistically simulate transfer of pencil-lead material to the paper, the pencil tip model is updated after each point along the line is processed. For example, where the tip model is based on sampling only the tip surface, points that intersect cells can be moved upward along the pencil axis. In one embodiment, each point is moved by 1/1000 of its penetration depth d(pₖ). The amount of movement can be varied to simulate varying degrees of pencil hardness. In some embodiments, as points are moved, the density of the pencil tip may become less uniform. Although not quite realistic, the model is satisfactory for many purposes; enhanced realism can be achieved by periodically resampling the tip using the eroded shape defined by the existing sample set.

In other embodiments, the tip model includes samples for the entire volume of the tip. Where this is the case, erosion can be simulated by deleting points that intersect cells.

### Example Images

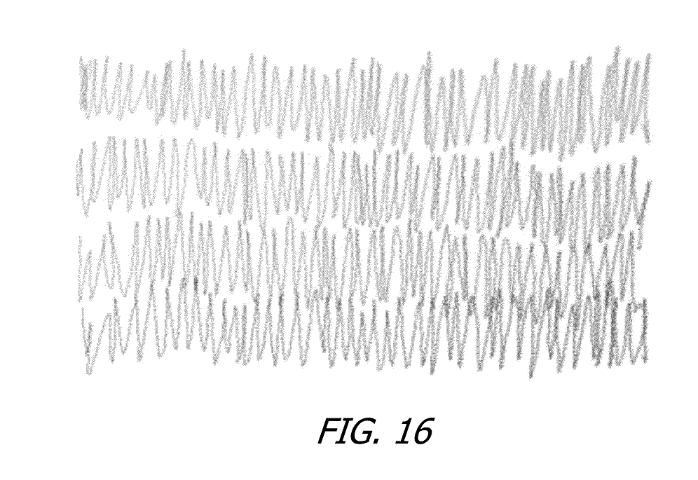

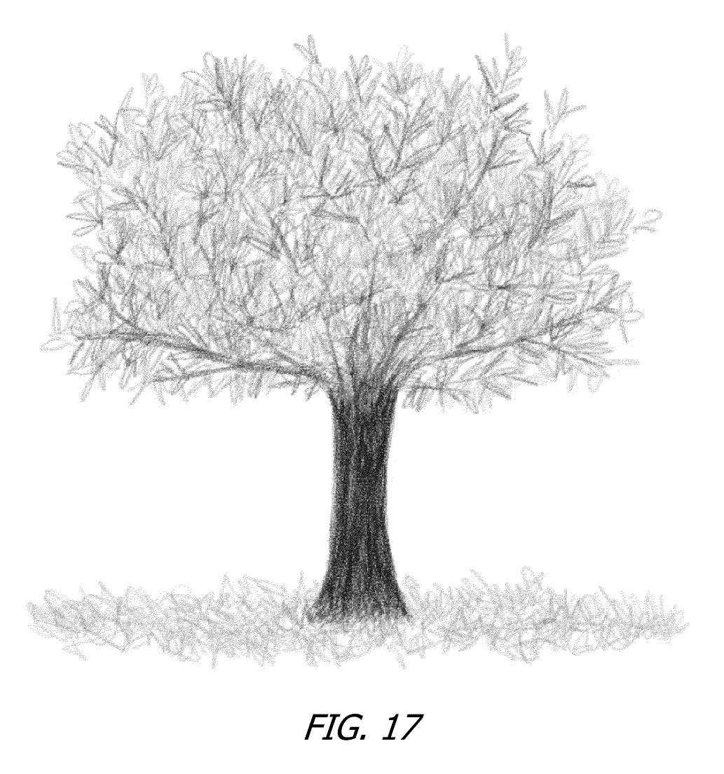

FIGS. 16 and 17 are examples of images rendered using the techniques described herein. FIG. 16 shows a number of pencil lines, each drawn from left to right. As can be seen, each line widens slightly due to pencil erosion. FIG. 17 shows a drawing of a tree.

### Further Embodiments

While the invention has been described with respect to specific embodiments, one skilled in the art will recognize that numerous modifications are possible. For example, in some embodiments described above, a pencil is used as the drawing tool; the pencil can be, e.g., a graphite, charcoal or colored pencil. Further, the invention is not limited to rendering pencil strokes. Similar models can be used to render strokes or lines with the appearance of being generated by other drawing tools that operate by transferring portions of a solid pigment mass from the tool to the drawing surface, including but limited to chalk, oil chalk, crayon, and the like. Likewise, although paper is referred to above as a drawing surface, other drawing surfaces can also be modeled, including but not limited to canvas, wood, concrete, plaster, and so on.

Thus, although the invention has been described with respect to specific embodiments, it will be appreciated that the invention is intended to cover all modifications and equivalents within the scope of the following claims.

### REFERENCES

[CAS97] C. J. Curtis, S. E. Anderson, J. E. Seims, K. W. Fleischer, and D. H. Salesin. Computer-generated watercolor. In Proceedings of the 24th Annual Conference on Computer Graphics and Interactive Techniques, pp. 421-430. (ACM Press/Addison-Wesley) (1997).
[DFR04] D. DeCarlo, A. Finkelstein, and S. Rusinkiewicz. Interactive rendering of suggestive contours with temporal coherence. In Proceedings of the 3rd International Symposium on Non-Photorealistic Animation and Rendering, pp. 15-145 (ACM) (2004).
[GVH07] T. Goodwin, I. Vollick, and A. Hertzmann. Isophote distance: a shading approach to artistic stroke thickness. In Proceedings of the 5th Annual Symposium on Non-Photorealistic Animation and Rendering (ACM) (2007).
[HM92] C. S. Haase and G. W. Meyer. Modeling pigmented materials for realistic image synthesis. ACM Transactions on Graphics, 22(3):848-855 (2003).
[IHS02] T. Isenberg, N. Halper, and T. Strothotte. Stylizing silhouettes at interactive rates: From silhouette edges to silhouette strokes. In Computer Graphics Forum, v. 21, pp. 249-258 (2002).
[Kal04] R. D. Kalnins Wysiwyg npr: interactive stylization for stroke-based rendering of three-dimensional animation (2004).
[KM31] P. Kubelka and F. Munk. Ein Betrag zur Optik der Farbanstriche, Z. tech. Physik, 12:593-601 (1931).
[Kor69] G. Kortum. Reflexionsspektroskopie: Grundlagen, Methodik, Anwenungen. Springer-Verlag (1969).
[Kub54] P. Kubelka. New Contributions to the Optics of Intensely Light-Scattering Materials. Part II: Nonhomogeneous Layers. Optical Society, 44:330-334 (1954).
[NM00] J D Northrup and L. Markosian. Artistic silhouettes: A hybrid approach. In Proceedings of the 1st International Symposium on Non-Photorealistic Animation and Rendering, pp. 31-37 (ACM) (2000).
[RMN03] D. Rudolf, D. Mould, and E. Neufeld. Simulating wax crayons. In Proceedings, 11th Pacific Conference on Computer Graphics and Applications, 2003, pp. 163-172 (2003).
[RMN05] D. Rudolf, D. Mould, and E. Neufeld. A bidirectional deposition model of wax crayons. In Computer Graphics Forum, v. 24, pp. 27-39 (Blackwell Publishing Ltd.) (2005).
[SB00] M. C. Sousa and J. W. Buchanan. Observational models of graphite pencil materials. In Computer Graphics Forum, v. 19, pp. 27-49. (Blackwell Science Ltd.) (2000).
[SP03] M. C. Sousa and P. Prusinkiewicz. A few good lines: Suggestive drawing of 3d models. In Computer Graphics Forum, v. 22, pp. 381-390. (Blackwell Publishing Ltd.) (2003).
[TNF99] S. Takagi, M. Nakajima, and I. Fujishiro, Volumetric modeling of colored pencil drawing. In Pacific Graphics 99 (1999).
[YMI04] S. Yamamoto, X. Mao, and A. Imamiya. Colored pencil filter with custom colors. In Proceedings, 12th Pacific Conference on Computer Graphics and Applications, 2004. PG 2004, pp. 329-338 (2004).

What is claimed is:

1. A digital drawing system that emulates interaction of a drawing tool with a drawing surface, the system comprising:
a memory configured to store a drawing tool model that includes a constellation of tip points and a drawing surface model that includes a plurality of cells of different heights, each cell having associated color parameters;
intersection logic configured to receive line parameters associated with a stroke to be rendered, the line parameters including a sequence of points and further configured to determine an intersection of the constellation of tip points with one or more underlying cells of the plurality of cells when the drawing tool model is placed at a point on the line;
update logic configured to modify cell heights and color parameters in the drawing surface model to emulate transfer of pigment from the drawing tool tip to the one or more underlying cells and to modify the drawing tool model to emulate erosion of the drawing tool tip; and
color logic configured to compute a pixel color based on the color parameters of one or more of the plurality of cells of the drawing surface model.

2. The digital drawing system of claim 1 further comprising:
a user-operable input device including a stylus; and
input processing logic configured to generate the line parameters in response to user operation of the stylus.

3. The digital drawing system of claim 2 wherein the line parameters further include a pressure and a tilt angle determined from user operation of the stylus.

4. The digital drawing system of claim 1 wherein the drawing tool tip model is a model of one of a graphite pencil, a charcoal pencil, a colored pencil, a chalk, an oil chalk, or a crayon.

5. The digital drawing system of claim 1 wherein the update logic is further configured such that modifying the drawing surface model includes defining a footprint consisting of a subset of the tip points and determining which cells of the plurality of cells are intersected by the footprint.

6. The digital drawing system of claim 1 wherein the update logic is further configured such that modifying the drawing tool tip model to emulate erosion of the drawing tool tip includes moving one or more of the tip points in the constellation to a new location.

7. A method for generating an image, the method comprising:
storing a drawing tool model in a memory of a computer system, wherein the drawing tool model includes tip-point data representing a constellation of tip points arranged in a tip shape;
storing a paper model in the memory, wherein the paper model includes cell data for a plurality of cells, the cell data for each cell including a cell height and a cell color;
identifying a line to be rendered, the line consisting of a plurality of points; and
successively rendering each point on the line, wherein rendering each point on the line includes:
determining an intersection of the constellation of tip points and one or more of the cells;
for each cell that intersects the constellation of tip points, computing an updated color and storing the updated color in the paper model; and
modifying the constellation of tip points to emulate erosion of the tip prior to rendering a next point on the line.

8. The method of claim 7 wherein rendering each point on the line includes, for each cell that intersects the constellation of tip points:
computing an increment to the cell height; and
adding the increment to the stored cell height in the cell model.

9. The method of claim 7 wherein modifying the constellation of tip points includes changing a position of at least one of the tip points in the constellation.

10. The method of claim 7 wherein modifying the constellation of tip points includes removing at least one of the tip points from the constellation.

11. The method of claim 7 wherein computing the updated color for one of the cells includes:
applying a probabilistic model to determine a thickness of a transferred pigment layer for the cell; and
modifying one or more color parameters for the cell based at least in part on the thickness of the transferred pigment layer.

12. The method of claim 7 wherein determining the intersection of the constellation of tip points and one or more of the cells includes:
defining a footprint including a subset of the tip points selected according to distance from a nominal paper surface;
associating each point in the footprint with an underlying cell from the plurality of cells of the paper model; and
determining whether each of the underlying cells is penetrated by the footprint.

13. The method of claim 12 wherein determining whether each of the underlying cells is penetrated by the footprint includes, for one of the underlying cells:
computing an average penetration depth of the points in the footprint associated with the one of the underlying cells; and
comparing the average penetration depth to the height of the one of the underlying cells.

14. The method of claim 12 wherein defining the footprint includes:
establishing a maximum value for a surface area parameter;
sorting the tip points into a sorted list based on the distance of each tip point from the nominal paper surface; and
iteratively adding a next tip point from the sorted list and updating a surface area parameter until the maximum value of the surface area parameter is reached.

15. The method of claim 14 wherein the maximum value of the surface area parameter is based at least in part on an applied pressure associated with the point on the line.

16. The method of claim 7 wherein the drawing tool model includes a model of a pencil.

17. The method of claim 7 wherein the drawing tool model includes a model of any one of a graphite pencil, a charcoal pencil, a colored pencil, a chalk, an oil chalk, or a crayon.

18. A computer-readable storage medium encoded with program code that, when executed by a processor of a computer system, cause the processor to render a line as a stroke made by a drawing tool, the program code comprising:
program code for defining a drawing tool model, wherein the drawing tool model includes tip-point data representing a constellation of tip points arranged in a tip shape;
program code for defining a paper model, wherein the paper model includes cell data for a plurality of cells, the cell data for each cell including a cell height and a cell color;
program code for identifying a line to be rendered, the line consisting of a plurality of points; and
program code for successively rendering each point on the line, wherein the program code for rendering each point on the line includes:
program code for determining an intersection of the constellation of tip points and one or more of the cells;
program code for computing an updated color for each cell that intersects the constellation of tip points and storing the updated color in the paper model; and
program code for modifying the constellation of tip points to emulate erosion of the tip prior to rendering a next point on the line.

19. The computer readable storage medium of claim 18 wherein the program code for determining the intersection of the constellation of tip points and one or more of the cells includes:
program code for defining a footprint including a subset of the tip points selected according to distance from a nominal paper surface;
program code for associating each point in the footprint with an underlying cell from the plurality of cells of the paper model; and
program code for determining whether each of the underlying cells is penetrated by the point in the footprint.

20. The computer readable storage medium of claim 19 wherein the program code for determining whether each of the underlying cells is penetrated by the footprint includes, for one of the underlying cells:
program code for computing an average penetration depth of the points in the footprint associated with the one of the underlying cells; and
program code for comparing the average penetration depth to the height of the one of the underlying cells.
